(19) United States
(12) Patent Application Publication
(10) Pub. No.: US 2025/0388408 A1
(43) Pub. Date: Dec. 25, 2025

(54) Conveyor Module With Elevatable Outside Edge

(71) Applicant: Safari Belting Systems, Inc., Olathe, KS (US)

(72) Inventor: Christopher J. Smith, Leawood, KS (US)

(21) Appl. No.: 19/244,948

(22) Filed: Jun. 20, 2025

Related U.S. Application Data
(60) Provisional application No. 63/662,187, filed on Jun. 20, 2024.

(51) Int. Cl. B65G 17/08

(52) U.S. Cl. CPC B65G 17/083

(57) ABSTRACT

A conveyor system module is disclosed having an edge recess with an edge clearance to a carryway. The edge clearance permits insertion of a fulcrum edge of a rotatable lever for cleaning beneath the module. The module has a landing on the bottom surface that extends between the outside edge and the drive bar to receive the lifting edge of the lever when rotated and facilitate cleaning across the entire bottom of the module.

### CROSS-REFERENCE TO RELATED ART

This application claims the benefit of U.S. Provisional Application Number 63/662,187, filed June 20, 2024, which application is hereby incorporated herein by reference, in its entirety.

### TECHNICAL FIELD OF INVENTION

The invention relates generally to a conveyor system, including retail product conveyor systems and for use in package handling, processing, distribution, and sorting. The invention more particularly relates to a module having an edge recess for insertion of a pivotal lever for cleaning beneath the module.

### BACKGROUND OF THE INVENTION

In the retail shipping industry, as well as meat and meat packing industries, conveyor belts and conveyor systems are commonly utilized to transport product. The most frequently employed conveyor systems comprise a number of interlocking conveyor modules pivotally linked together to form a continuous conveyor belt, which is driven by a sprocket. It is common to have rotatable rollers mounted on axles that are mounted on the conveyor modules.

It is common for debris to build up above and below the conveyor belt. Debris passing between the rollers and gaps between modules allows the build-up of debris on the bottom side of the modules. Cleaning beneath the modules is difficult.

It is also known to connect modules with perforated surfaces. Transported media commonly sheds debris that passes through the perforated surface to the bottom side of the module where it is hard to clean.

System sanitation is conducted nightly in meat facilities. The sanitation crews must clean the conveyor frame and belt along with all other equipment. The time permitted for sanitation operations is very limited. Because most meat processing plants run two production shifts, only about six hours is available to completely clean, sanitize and have the USDA inspect all the equipment inside the facility.

If the USDA does not certify the plant is clean, the plant cannot operate and must be recleaned. Therefore, anything that assists the sanitation crew to expedite their cleaning tasks is critical to keeping production online.

To facilitate thorough cleaning, belt lifters are provided. These devices may typically lift the belt vertically about twelve inches above the conveyor. A disadvantage of these devices is that although they allow some access to the conveyor frame, they do not provide easy access to the bottom side of the belt. Another disadvantage to these devices is that they provide only limited access to the conveyor frame. Another disadvantage of these devices is that they add significant metal structure to the underside of the conveyor frame that must also be sanitized.

Another method that is known to be used is to tilt the belt up so the bottom side of the belt can be easily accessed. An advantage of this method is that it is quicker, and also allows better access to the conveyor frame. By tilting the belt to the 10:00-11:00 o'clock position, both the belt and conveyor frame are readily accessible for rapid sanitation.

This method is conventionally practiced by having the sanitation crew use rope, meat hooks, pipe or anything they can find to tilt the belt up. One disadvantage of this method is that sanitation crews frequently damage the outside edge of the conveyor belt, and can create an unacceptable and difficult to detect contaminate. Another disadvantage is that the practice lacks designed complementary equipment to quickly and safely tilt the belt in a secure manner.

Another disadvantage is that the method is difficult to perform on modules having a thickened outer edge without damaging the outer module. Modules having thickened outer edges provide protection to workers from pinching their fingers when working near and around the moving modules, but they lack any unforced access for a lifting tool that most other modules have.

Another disadvantage to the method is modules with thickened edge sections conventionally have thickened bottom portions, and rib continuations that extend to the bottom portions. These configurations resist secure engagement with any lifting apparatus used to tilt the belt for cleaning, creating a potential safety hazard.

It is also known to create modules with wear pads on the external underside of the modules for support of the weight on the conveyor and to extend the life of the underside of the modules. Designs such as this include, for example, U.S. Patent 11,772,897. However, it is still necessary to keep the bottom surface of the modules free of debris. There is also a need to have quick and immediate external access to lift the module to permit pressurized cleaning.

Therefore, there is a need for a conveyor system that addresses these problems associated with the conventional systems. In particular, a conveyor system is needed that is easy to manufacture and is durable, protects the safety of the worker's fingers, provides tool access for lifting, and improved flow paths for pressurized fluid to clean beneath the module sections.

### SUMMARY OF THE INVENTION

One advantage of the various embodiments of the present invention is that it provides a wide outside edge to the module that protects the workers from pinching their fingers.

Another advantage is that it provides a module that even though it has a wide outside edge, it can be quickly engaged and raised sufficiently without breaking in relation to its unstressed operating position to provide access for cleaning.

Another advantage is that it provides a fulcrum edge on the module with an edge clearance for receiving a lifting edge of lever for engaging and lifting the module to provide access for cleaning.

Another advantage is that it provides a configuration for receiving a lever in secure engagement with the bottom of the module to prevent lateral movement of the lever when engaged with the module.

Another advantage of the various embodiments of the disclosed invention is that it is durable. Another advantage is that it is inexpensive to manufacture.

In one embodiment, the module comprises a leading edge and an opposite trailing edge, a top surface, and an opposite bottom surface, and an outside edge and an opposite inside edge. The module has a plurality of first links located along the leading edge, including an outermost link located closest to the outside edge. There is a plurality of second links located along the trailing edge, offset from the first links.

The module has a module extension extending between the outside edge and the outermost link, and a bullnose formed on the leading edge between the outside edge and the outermost link. The outside edge extends downward from the bottom surface and is adjoined to the bullnose. There is a lift edge on a bottom of the outside edge. A drive bar extends downward from the bottom of the module and extends from the inside edge to the module extension. The bottom surface of the module extends between the leading edge and the trailing edge, and between the outside edge and the drive bar.

The drive bar has opposing walls and a crest connecting them. In another embodiment, the first links and second links have a rod pocket for receiving a connecting rod and a contact surface at the lowest point of each of the first and second links.

In another embodiment, an edge clearance is formed between the crest of the drive bar and the fulcrum edge. In another embodiment, an edge clearance exists between the fulcrum edge and the contact surfaces of the first and second links, which are located at the lowest point of the first and second links.

In another embodiment, the crest extends below the fulcrum edge. In another embodiment, the contact surfaces of the first and second links extend below the fulcrum edge.

In another embodiment, a rod pocket is formed between the outside edge, the bullnose, the outermost link, and the bottom. In another embodiment, the edge clearance is receivable of a lever, and the lever is rotatable to lift the module to permit cleaning beneath the module.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The objects and features of the invention will become more readily understood from the following detailed description and appended claims when read in conjunction with the accompanying drawings in which like numerals represent like elements.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a first top isometric view of an embodiment of the disclosed invention.

FIG. 2 is a first bottom isometric view of the embodiment of FIG. 1.

FIG. 3 is a second top isometric view of the embodiment of FIG. 1.

FIG. 4 is a second bottom isometric view of the embodiment of FIG. 1.

FIG. 5 is a front view of the module leading edge of the embodiment of FIG. 1.

FIG. 6 is an end view of the module outside edge of the embodiment of FIG. 1.

FIG. 7 is a rear view of the module trailing edge of the embodiment of FIG. 1.

FIG. 8 is an end view of the module inside edge of the embodiment of FIG. 1.

FIG. 9 is side view of the trailing edge of the embodiment of FIG. 1, illustrating the lever in initial engagement with the module.

FIG. 10 is a side view of the trailing edge of the embodiment of FIG. 9, illustrating the lever rotationally actuated to begin lifting the module outside edge.

FIG. 11 is an isometric view illustrating the lever engaged beneath the module and having fully tilted the module for full access cleaning.

FIG. 12 is a force diagram, illustrating the module deflection when various weights are placed over the outside edge.

### DETAILED DESCRIPTION OF THE PREFERRED EMBODIMENTS

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail.

The following description is presented to enable any person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

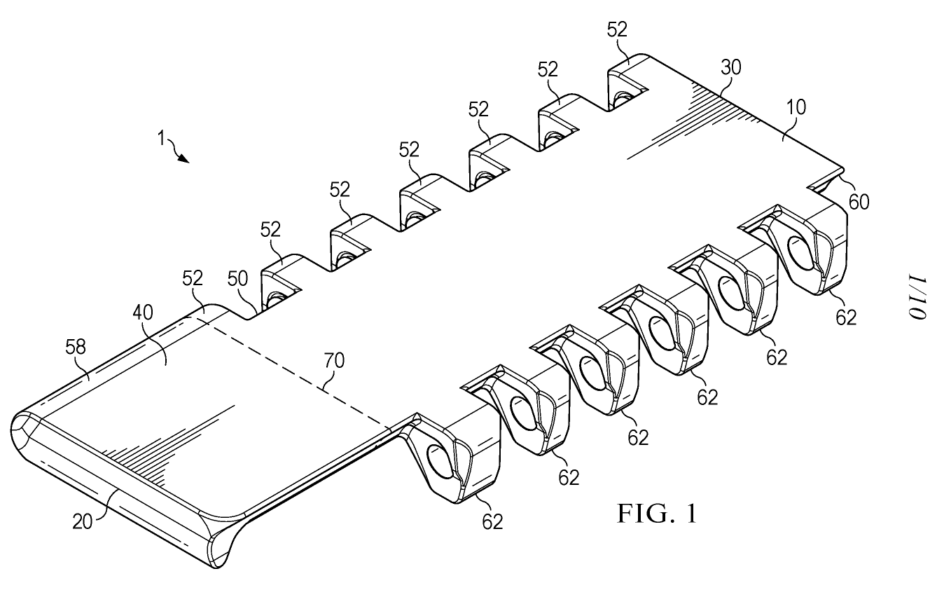

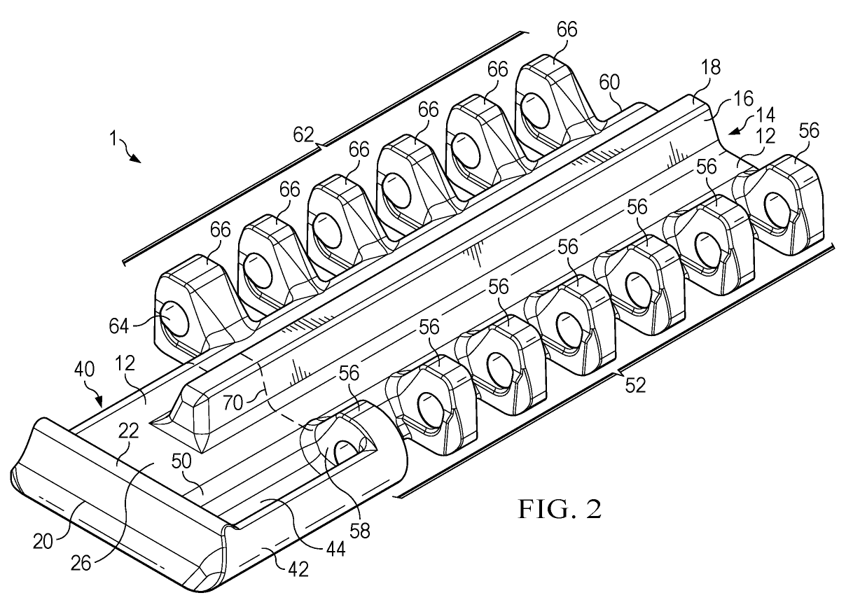

FIG. 1 is a first top isometric view of an embodiment of the disclosed invention. Module 1 has a top 10. Referring to FIG. 2, module 1 has an opposite bottom 12. Referring back to FIG. 1, module 1 has an outside edge 20 and an opposite inside edge 30. Module 1 has a leading edge 50 and an opposite trailing edge 60. Module 1 has an extension 40 adjacent to outside edge 20. Top 10 of module 1 extends over extension 40.

A plurality of first links 52 extend from leading edge 50. Each of first links 52 has a port 54 (see FIG. 2). A plurality of second links 62 extend from trailing edge 60. Each of second links 62 has a port 64. Ports 54 and ports 64 are receivable of a pivot rod (not illustrated). The pivot rod pivotally connects first links 52 of a first module 1 to second links 62 of an adjacent second module 1 in the manner that is well known in the conveyor industry.

FIG. 2 is a first bottom isometric view of the embodiment of FIG. 1. A drive bar 14 extends downward from bottom 12 of module 1. Drive bar 14 has a pair of opposing walls 16 and a crest 18 connecting them to define the lowest extent of drive bar 14 and module 1. Outside edge 20 has a fulcrum edge 22.

Among first links 52 is an outer link 58. Outer link 58 is the outermost link that is most proximate to outside edge 20. A bullnose 42 extends between outside edge 20 and outer link 58. A rod pocket 44 is formed between outside edge 20, bullnose 42 and outer link 58.

Bottom 12 extends over to the underside of extension 40. Bottom 12 extends between drive bar 14 and outside edge 20, and between leading edge 50 and trailing edge 60. The extension of bottom 12 between drive bar 14 and outside edge 20 allows for divided fluid flow around drive bar 14 and between drive wall 16 and first links 52 and also between drive wall 16 and second links 62. This clearance further assures optimized cleaning of rod pocket 44. This is an advantage of the invention over the prior art of thickened edge portions.

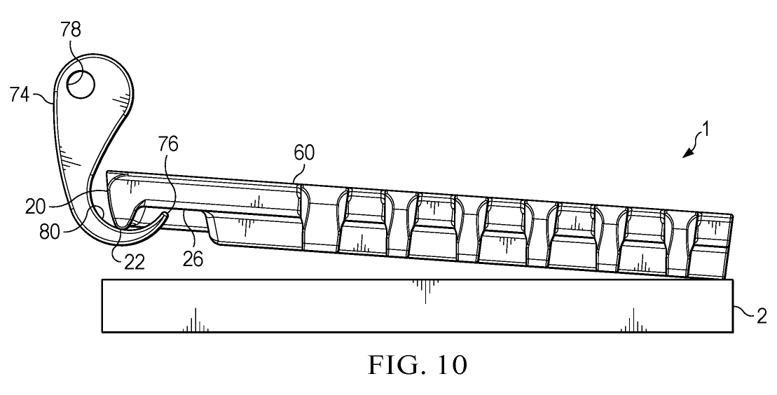

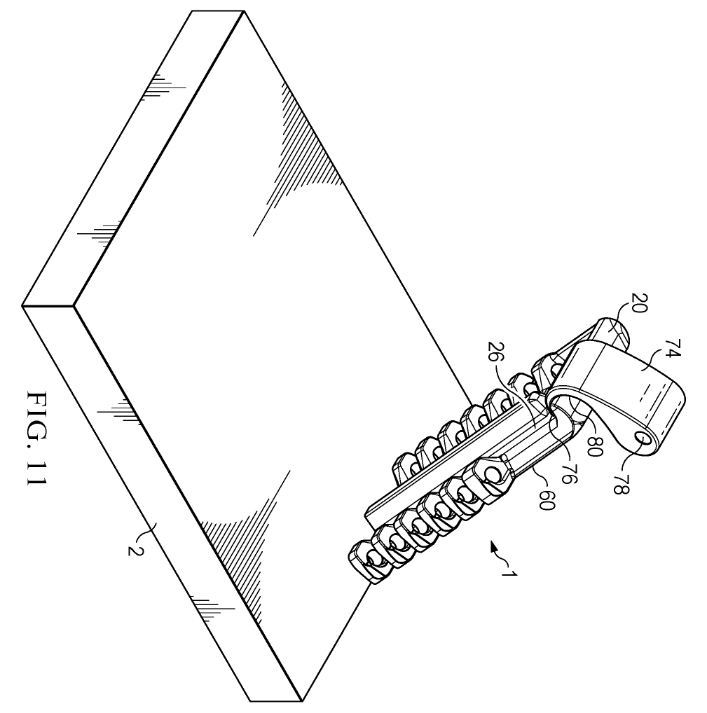

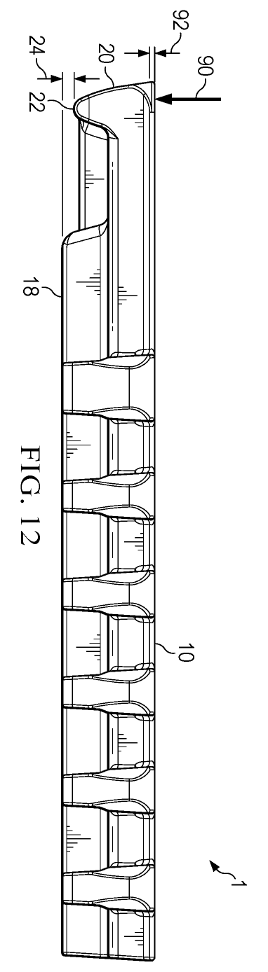

A landing 26 is provided on bottom 12 of module 1. Landing 26 is located between drive bar 14 and outside edge 20 on the underside of extension 40. As will be shown in FIGS. 10 and 11, landing 26 provides a relief between outside edge 20 and drive bar 14 for receiving a lever 74.

As best seen in FIG. 1, extension 40 extends from leading edge 50 to trailing edge 60 and between outer link 58 and outside edge 20.

Each of first links 52 has a contact surface 56. Each of second links 62 has a contact surface 66. Contact surfaces 56 and 66 define the lowest extents of first links 52 and second links 62, and of module 1, along with, and in the same plane with crest 18.

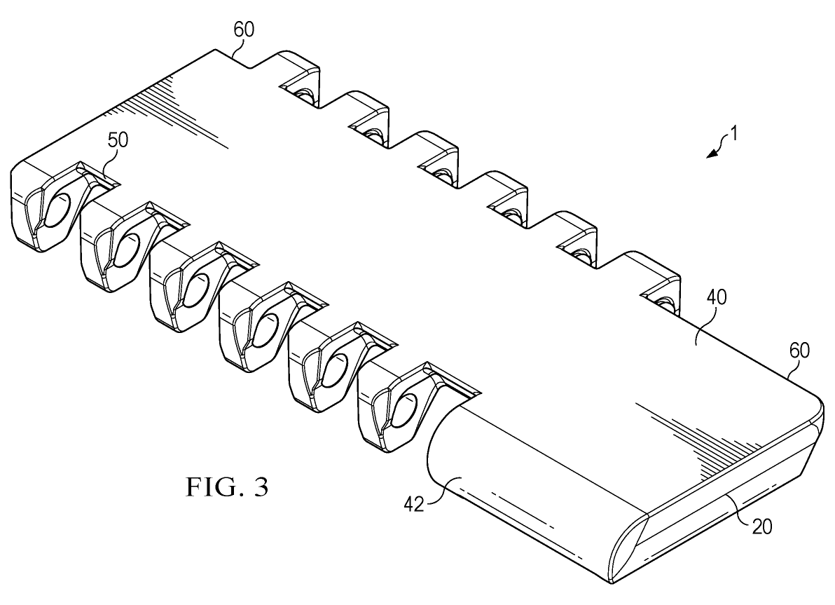

FIG. 3 is a second top isometric view of the embodiment of FIG. 1. FIG. 3 clearly illustrates the portion of module 1 and top 10 where extension 40 resides beyond demarcation 70.

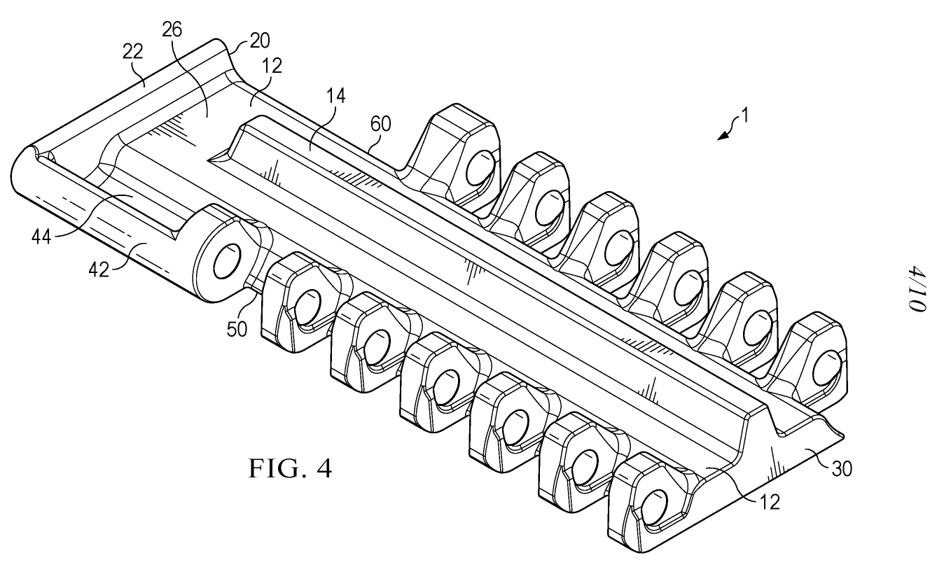

FIG. 4 is a second bottom isometric view of the embodiment of FIG. 1. As seen in FIGS. 3 and 4, outer link 58 is contiguous to bullnose 42, and bullnose 42 intersects with outside edge 20 to enclose rod pocket 44. Landing 26 is located between drive bar 12 and outer edge 20.

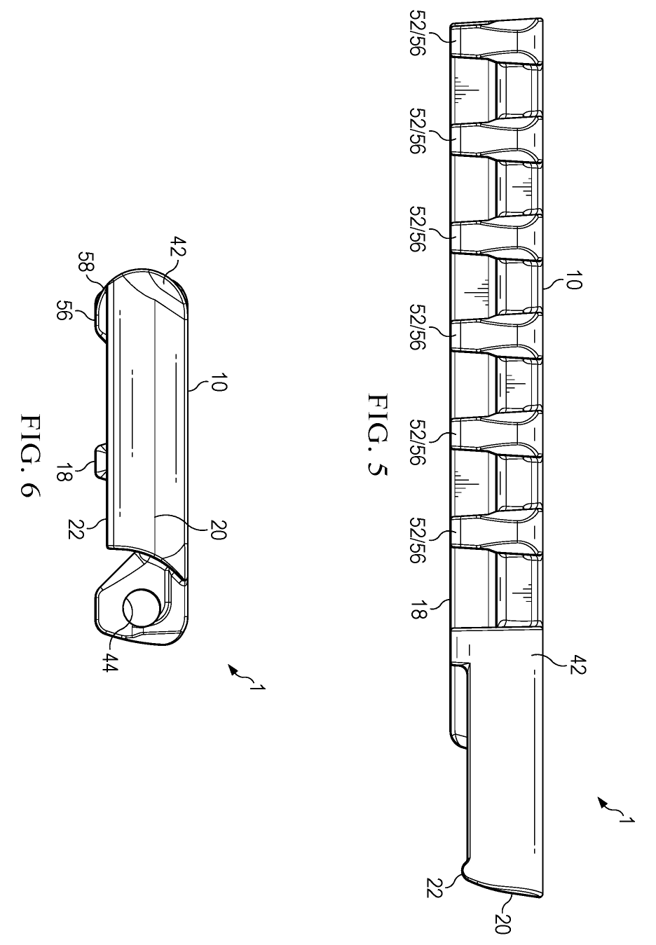

FIG. 5 is a front view of module 1, looking toward leading edge 50 of the embodiment of FIG. 1. As seen in this view, each of first links 52 has a contact surface 56. As also seen from this view, contact surfaces 56 are in the same plane as crest 18.

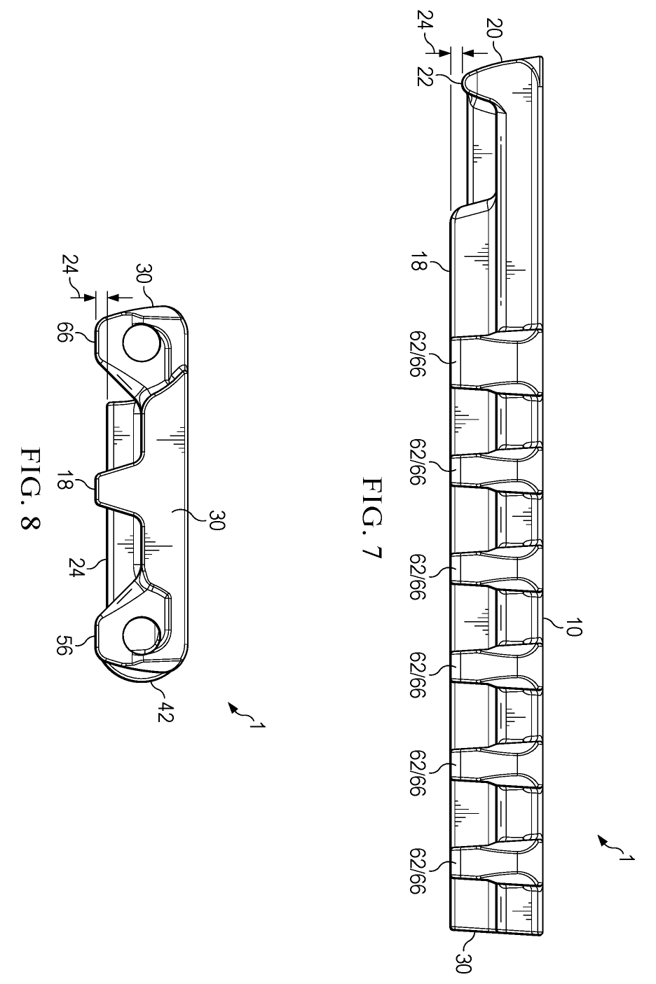

An edge clearance 24 exists between contact surfaces 56 of first links 52 and fulcrum edge 22 (see FIG. 7). The same edge clearance 24 exists between crest 18 and fulcrum edge 22. In the embodiment illustrated, edge clearance 24 is 2mm (.078 inches). Edge clearance 24 provides an access point for a lever 74. Edge clearance 24 prevents fulcrum edge 22 from contact and or wear with a carryway 2 (see FIG. 10).

In the embodiment illustrated, edge clearance 24 is about 2 mm (.078 inches). Edge clearance 24 is sized to prevent pinching of fingers of operators but to still allow access for the lever. Lever 74 permits hoisted cleaning of bottom 12, drive bar 14, rod pocket 44, and all of the underside of module 1.

FIG. 6 is an end view of the module outside edge 20 of the embodiment of FIG. 1.

FIG. 7 is a rear view of module 1, looking towards trailing edge 60 of the embodiment of FIG. 1. As seen in this view, each of second links 62 has a contact surface 66. As also seen from this view, contact surfaces 66 are in the same plane as crest 18. Edge clearance 24 exists between contact surfaces 66 of second links 62 and fulcrum edge 22. The same edge clearance 24 exists between crest 18 and fulcrum edge 22.

FIG. 8 is an end view of the module 1 inside edge 30 of the embodiment of FIG. 1.

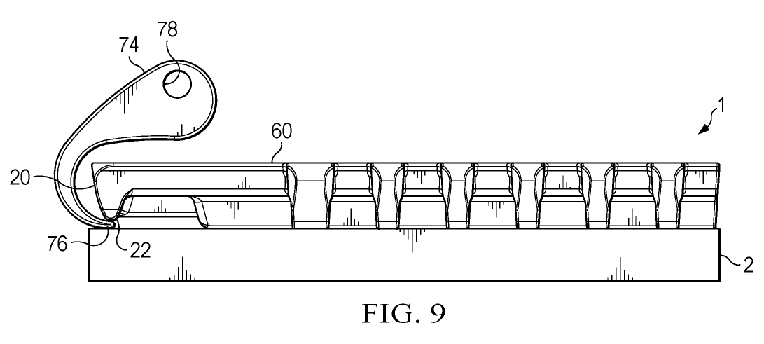

FIG. 9 is a side view of module 1 trailing edge 60 of the embodiment of FIG. 1, illustrating lever 74 in initial engagement with module 1. In this view, lever 74 has its lifting edge 76 positioned beneath fulcrum edge 22 on outside edge 20 of module 1. An orifice 78 is located on lever 74, on an end distal to lifting edge 76. Orifice 78 permits connection of lever 74 to a lifting mechanism to sustain a raised position of module 1 for safe and secure cleaning. This feature allows a single employee to effectively clean beneath the conveyor system of which module 1 is a component.

FIG. 10 is a side view of trailing edge 60 of the embodiment of FIG. 9, illustrating lever 74 partially lifted, causing counterclockwise rotation of lever 74, and full engagement of lever 74 with module 1. In the embodiment illustrated, lever 74 has a radiused cradle 80. Rotation of lever 74 causes lifting edge 76 to proceed towards landing 26 behind outside edge 20, while fulcrum edge 22 translates into secured engagement in cradle 80 of lever 74.

FIG. 11 is an isometric view illustrating lever 74 engaged beneath module 1 and having fully tilted (rotated) module 1 in relation to carryway 2 for full access cleaning. In this view, lever 74 has been raised by a connection to orifice 78. Lifting edge 76 is translated to engage bottom 12 of module 1 and may engage landing 26 without interference with drive bar 14. Landing 26 extends between outside edge 20 and drive bar 14 to receive lifting edge 76 of lever 74 when rotated and further to facilitate a path for pressurized fluid cleaning across the entire bottom 12 of module 1.

FIG. 12 is a force diagram, illustrating a load (force) 90 applied on top surface 10 of module 1 proximate to outside edge 20. Outside edge 20 is deflected by a distance 92. If a load 90 results in a deflection greater than or equal to edge clearance 24, then fulcrum edge 22 would contact carryway 2 and frictional wear would result. As seen, the width of lever 74 provides an extended and secure engagement with module 1 that prevents premature release of module 1 under the cleaning force of pressurized fluid sanitation.

Solid modeling results for a load 90 of 12.5 lbs. placed over outside edge 20 demonstrate that edge clearance 24 is reduced insignificantly. Where an unloaded edge clearance 24 is 2mm (.078 inches), solid modeling shows a maximum deflection 92 of only .15 mm (0.006 inches), leaving an edge clearance 24 of 1.85 mm (0.073 inches).

Solid modeling results for a load 90 of 25 lbs. placed over outside edge 20 demonstrate that sufficient edge clearance 24 remains to avoid frictional wear. Where solid modeling shows a maximum deflection 92 as loaded, edge clearance 24 is reduced by a maximum deflection of .30 mm (0.012 inches), leaving a reduced edge clearance of 1.70 mm (0.067 inches).

An advantage of the disclosed embodiment of the invention is that it provides a conveyor module that provides protection to the hands of operators.

An advantage of the disclosed embodiment of the invention is that it provides a module securely receivable of a lever designed for securing the outer edge of a modular conveyor belt, by pivotal engagement with the modular in a manner that increases the security of the engagement as the tilt angle increases.

Another advantage is that it provides a module design and lever connection that prevents chipping of the outer edge of the module when tilting the modular conveyor belt for sanitation.

Another advantage of the disclosed embodiment of the invention is that it provides a safe and efficient means for tilting a modular conveyor belt for rapid deployment and sanitation.

Another advantage of the disclosed embodiment of the invention is that it provides a conveyor module that prevents wear of its outer safety edge.

Another advantage of the disclosed embodiment of the invention is that it provides a conveyor module that has improved fluid flow properties on its bottom side for improved cleaning.

It will be readily apparent to those skilled in the art that the general principles defined herein may be applied to other embodiments and applications without departing from the spirit and scope of the present invention.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered desirable by those skilled in the art based upon a review of the foregoing description of preferred embodiments. Accordingly, it is appropriate that the appended claims be construed broadly and in a manner consistent with the scope of the invention.

1. A conveyor belt module, comprising:
a leading edge and an opposite trailing edge;
a top surface, and an opposite bottom surface;
an outside edge and an opposite inside edge;
a plurality of first links located along the leading edge, and having an outermost link located closest to the outside edge;
a plurality of second links located along the trailing edge, and offset from the first links;
the module having a module extension extending between the outside edge and the outermost link;
a bullnose formed on the leading edge between the outside edge and the outermost link;
the outside edge extending downward from the bottom surface and adjoined to the bullnose;
a fulcrum edge on a bottom of the outside edge; and,
an edge clearance separating the fulcrum edge from the bottom.

2. The conveyor belt module of claim 1, further comprising:
a drive bar extending downward from the bottom of the module and extending from the inside edge to the module extension; and,
the bottom surface of the module extending between the leading edge and the trailing edge, and between the outside edge and the drive bar.

3. The conveyor belt module of claim 1, further comprising:
the first links and second links having a rod pocket for receiving a connecting rod and a contact surface at a lowest point of each of the first and second links.

4. The conveyor belt module of claim 2, further comprising:
the drive bar having opposing walls and a crest connecting them; and,
an edge clearance between the crest of the drive bar and the fulcrum edge.

5. The conveyor belt module of claim 3, further comprising:
an edge clearance between the fulcrum edge and the contact surfaces of the first and second links.

6. The conveyor belt module of claim 4, further comprising:
the crest of the drive bar extends below the fulcrum edge.

7. The conveyor belt module of claim 3, further comprising:
the contact surfaces of the first and second links extend below the fulcrum edge.

8. The conveyor belt module of claim 1, further comprising:
a rod pocket formed between the outside edge, the bullnose, the outermost link, and the bottom.

9. The conveyor belt module of claim 1, further comprising:
the edge clearance being receivable of a lever; wherein the lever is liftable and rotatable to tilt the module for cleaning beneath the module.

10. The conveyor belt module of claim 9, the lever further comprising:
an orifice;
an inner curve; and,
a lifting edge.

11. The conveyor belt module of claim 10, further comprising:
the lifting edge being thinner than the edge clearance.

12. The conveyor belt module of claim 10, further comprising:
the inner curve having a radius larger than the outside edge.

13. The conveyor belt module of claim 9, further comprising:
a landing formed on the bottom surface of the module between the drive bar and the outside edge.
